(19) United States
(12) Patent Application Publication
(10) Pub. No.: US 2015/0206237 A1
(43) Pub. Date: Jul. 23, 2015

(54) Method And System for Fundraising

(71) Applicant: Chian Chiu Li, Fremont, CA (US)

(72) Inventor: Chian Chiu Li, Fremont, CA (US)

(21) Appl. No.: 14/161,657

(22) Filed: Jan. 22, 2014

(51) Int. Cl. G06Q 40/04

(52) U.S. Cl. CPC G06Q 40/04

(57) ABSTRACT

Methods and systems are provided to help non-accredited investors select and purchase securities of startup companies. In one embodiment, a verification body is arranged to verify investment information. In another embodiment, a special investor is arranged. The special investor may be a professional with experience and connections in the industry, and may plan to help a startup with time and knowledge. Compensation scheme is set up to award the effort of special investor. Verified investment information is made available to investors in fundraising processes.

### CROSS REFERENCE TO RELATED APPLICATION

This application claims the benefit under 35 U.S.C. Sec. 119 of provisional patent application Ser. No. 61/761,703, filed Feb. 7, 2013.

### FEDERALLY SPONSORED RESEARCH

Not applicable

### SEQUENCE LISTING OR PROGRAM

Not applicable

### BACKGROUND

1. Field of Invention

This invention relates to fundraising, more particularly to information verification and presentation in fundraising and investor arrangement.

2. Description of Prior Art

Crowdfunding, also known as crowd funding, or equity crowdfunding, represents a new fundraising avenue for early stage companies or startups. It also provides a unique platform for regular people to pool money to invest in or support startups or efforts of others. Unlike traditional investment, where only accredited investors like bankers, venture capitalists, and angel investors are allowed to participate, crowdfunding enables unaccredited investors, i.e., ordinary folks, to become a venture investor in equity-based funding activities. Non-accredited investors, likely to be inexperienced and sometimes overoptimistic, are only allowed to contribute a small portion of his or her annual income to crowdfunding. Each crowdfunding project, on the other hand, has a funding cap, the maximum amount of money that can be raised, which may be regulated in the United States.

Crowdfunding platform is usually a portal website, which potential investors can access via the Internet to gather information and purchase securities of a small business. Startup companies in infant or initial stage may benefit from crowdfunding by selling certain amount of equity, usually a small amount, to the public to raise money, which may be in great need. Ordinary people may benefit from being able to participate in high-reward investment, which used to be an exclusive event reserved only for professionals and the riches.

A portal website, as an intermediary between investors and startups, serves as a broker to offer securities of aspiring companies and take orders from investors to complete security procurement. To deter fraud, a portal website is required by law to check background, status, and other conditions of a company before offering its securities for sale.

Crowdfunding opens up a door for regular people to invest in high-risk and high-return securities, and for startup companies to get funding from the public instead of more sophisticated and more demanding accredited investors. Everyone can access a funding website, look for appropriate early-stage business, and acquire securities in hope of high return.

Security transaction process may look simple and easy for a buyer/investor. However, the hard part is which company is a safe and rewarding bet. Looking at and studying information provided at a funding portal or startup's website may not be convincing enough, as these two are the broker and issuer, beneficiaries of security offering. Thus, information provided by the fourth party, which is neither related to a startup nor portal company, is desired by existing and potential investors.

Furthermore, many investors, as regular people, may not be familiar with the trade of a startup, and may also lack the skill to screen business plans and comprehend other materials like term sheet submitted by startups. Thus, opinions and decision by an old hand or industry insider may serve as a beacon for ordinary folks in startup selection. An old hand may come from a venture capital firm, or may be a serial individual investor. However, most likely accredited investors would shy away from crowdfunding due to the funding opportunity of relatively small amount of money which doesn't justify the lengthy diligence process carried out. On the other hand, as crowdfunding practice matures, more and more early-stage companies may seek financial support this way. The quantity of crowdfunding solicitation may become so large, for instance hundreds of thousands or even millions, that it could easily overwhelm any investment systems. Therefore, there is a need of investment guidance for regular people, which can't be satisfied by current funding resources.

It's quite common that startup entrepreneurs may be neither experienced in his or her management capacity nor well connected in the industry, especially for the first-timers. Thus, a burgeoning startup company may need not only money, but also education, knowledge and network which may be provided by a seasoned professional but don't necessarily come with raised funds. Thus startups are eager to learn from insiders and professionals but lack means to do it.

On the other hand, although seasoned professionals have skills, experience, and network built up over years of working in a trade, there are few ways for them to help a company while turning their knowledge into financial gains. Some angel investors help startups they invested by spending time with the founders and resolving tough issues encountered. However, angel investor has to be accredited and the financial requirements for that are out of reach for most people. Thus there is a need but lacks a way for professionals in a field to use their knowledge to assist startups and in the meantime to get monetary benefits from it.

Accordingly, there exist a need of independent verification body for investment information, a need of investment guidance for investors of regular folks, and a need of professional coaching and assistance for startups which seek and/or receive funds. There also exists a need of mechanism for seasoned professionals to utilize their knowledge to help startups and get compensated financially.

Such needs remain the same whether equity involves or not. In the latter case, when people pool money to support activities of others, the reward may be purely spiritual, like funding a struggling artist or community project, or a nominal gift in the future. As the nature is still investing, information verification and guidance of professionals are still critical.

### OBJECTS AND ADVANTAGES

Accordingly, several main objects and advantages of the present invention are:
a). to provide an improved method and system to help non-accredited crowdfunding investors, startups, and funding portals;
b). to provide such a method and system which establish a verification entity independent of portals and startups;
c). to provide such a method and system which verify information of startups, portals, and special investors who are experienced in a field and willing to assist startups using their experience and knowledge;
d). to provide such a method and system which financially award special investors who may contribute to startups not only money but also knowledge and network; and
e). to provide such a method and system which enable non-accredited investors to access verification results of investment information.

Further objects and advantages will become apparent from a consideration of the drawings and ensuing description.

### SUMMARY

Crowdfunding ushers in a new era of security acquiring for ordinary people, or non-accredited investors. But information provided by parties who are also funding beneficiaries may cause concerns. In addition, inexperienced investors may lack investment skills, and startup companies may need mentoring besides funding. Mentoring or coaching may be provided by seasoned professional; however, there lack incentives for professionals to participate. In accordance with the present invention, a verification body independent of funding portal and startup is proposed, which may verify investment-related information. Potential and existing investors may gain access of verification results which may help them make decisions on purchasing securities of startups. The verified info may include investment, credentials, and work plan of a special investor. The special investor may be seasoned in the industry and plan to assist a startup with time, knowledge and connections. The special investor may also serve as beacon for ordinary investors interested in a startup, because of his or her background and track record.

Therefore, non-accredited investors may benefit from independent verification entity which presents verified information and from the guidance of special investors. Startups may also benefit from the verification entity because it helps investors choose a startup in security offering events. Startups may benefit from the introduction of special investor as well, because a special investor may bring experience and network plus sending positive signals to other investors. Funding portals may benefit too, due to the enhanced investor confidence as a result of information verification. Lastly, special investors may benefit from the scheme as much as other parties, because it creates a way to utilize their knowledge and experience and get compensation accordingly. Therefore, arrangement of verification body and special investor may boost fundraising and produce a win-win situation for all parties in crowdfunding arena.

### DRAWING FIGURES

FIG. 1 is a block diagram of a prior-art crowdfunding environment.

FIG. 2 is a flow diagram showing prior-art investment process of crowdfunding.

FIGS. 3-A and 3-B are block diagrams showing crowdfunding embodiments in accordance with the present invention.

FIG. 4 is a diagram illustrating arrangement of special investor in accordance with the present invention.

FIG. 5 is a flow diagram depicting a process of special investor arrangement in accordance with the present invention.

FIG. 6 is a flow diagram depicting investment process of ordinary investors in accordance with the present invention.

FIG. 7 is a flow diagram showing a verification process in detail in accordance with the present invention.

FIGS. 8, 9, 10, 11, and 12 are graphic diagrams of five embodiments for crowdfunding event in accordance with the present invention.

REFERENCE NUMERALS IN DRAWINGS

| | | | |
|---|---|---|---|
| 10 | Investor | 12 | Issuer |
| 14 | Funding Portal | 16 | Verification Site |
| 18 | Webpage | 20 | Special Investor |
| 22 | Button | 24 | Webpage |
| 26 | Window | 28 | Button |
| 30 | Webpage | 32 | Window |
| 34 | Webpage | 36 | Webpage |
| 38 | Window | | |

100 to 142 are exemplary steps.

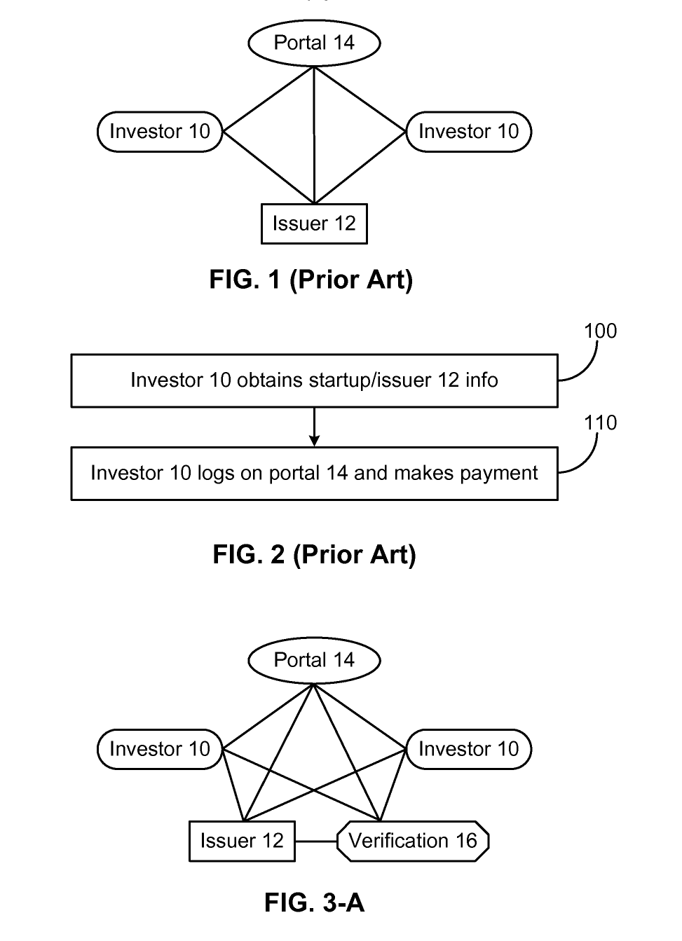

### DETAILED DESCRIPTION—FIGS. 1 AND 2—PRIOR-ART

FIG. 1 is a block diagram of prior-art crowdfunding configuration. An issuer 12, e.g., a startup, may want to sell securities to raise money. A number of investors 10 may want to invest in issuer 12 through purchasing its securities. Investors 10, as funders, may be non-accredited investors willing to take a risk in venture investment. In the setup, issuer 12, as a fundee, may not be able to sell securities to investors 10 directly; instead, issuer 12's securities and investors 10 are connected by an intermediary, a funding portal 14. Portal 14 may be a website registered as a broker in crowdfunding. Investors 10 may purchase securities of issuer 12 from portal 14 over the Internet.

FIG. 2 is a flow diagram of prior-art crowdfunding process. First, a startup or issuer 12 is reviewed thoroughly by portal 14 and found satisfying crowdfunding conditions and regulations. Next in Step 100, investor 10 obtains information of issuer 12 after logging on portal 14 or issuer 12's site. Investor 10 may be interested in supporting issuer 12 or buying securities of issuer 12, and may start registration procedures at portal 14. Investor 10 may submit info required by regulations, such as annual income or total asset. Portal 14 may run qualification process of investor 10 using data from other sources and calculate the maximum amount which investor 10 may be allowed to invest. Then in Step 110, investor 10 may make payment at portal 14 to place an order for a symbolic gift or purchase certain amount of securities of issuer 12. The amount of payment should not go beyond the maximum value mentioned.

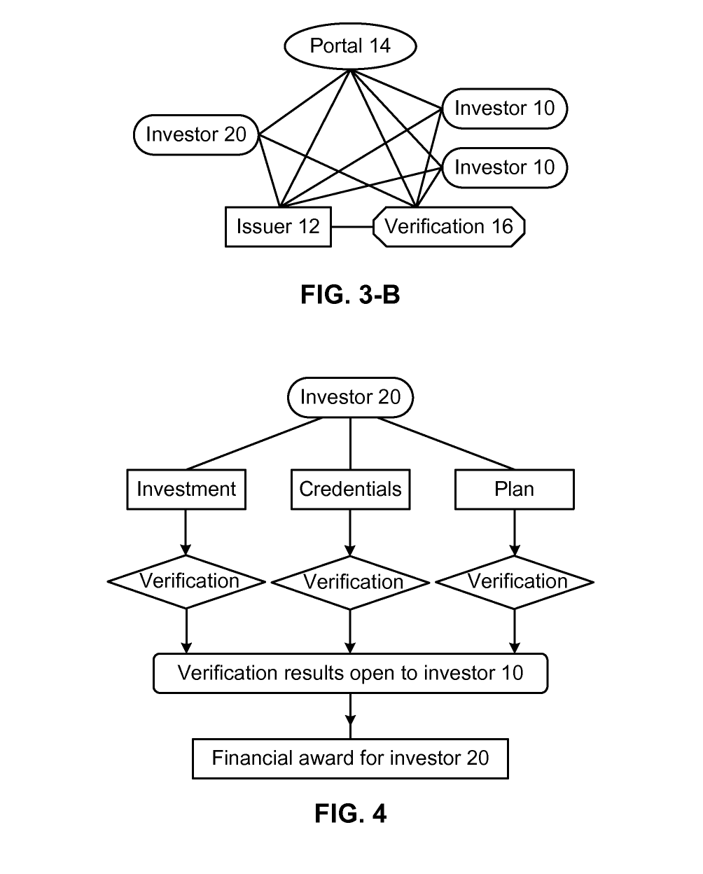

### FIGS. 3-A and 3-B Crowdfunding Environment

FIG. 3-A shows an exemplary block diagram of crowdfunding environment or configuration according to the present invention. Compared to the prior-art in FIG. 1, there is one added element in FIG. 3-A, a verification site 16. Verification 16 may be established as an independent entity from other parties to provide verified information about issuer 12, portal 14, and other related topics. Verified info may be arranged accessible to investor 10 at verification site 16. For instance, if investor 10 is interested in issuer 12, he or she may get info from issuer website and portal site. To do double check, investor 10 may log on verification site 16, where verified info may be available. For the convenience of users, issuer site and portal site may display a link button, which directs traffic to verification site 16. Once investment information is confirmed, investor 10 may log on portal site 14 to acquire securities.

Besides security-purchasing investors, verification 16 may serve the general public in non-equity-based funding too, since verified info is equally important when people just want to assist others' efforts financially.

FIG. 3-B shows another exemplary block diagram of crowdfunding configuration according to the present invention. The setting is a modification of FIG. 3-A, with a special investor 20 included. Investor 20, unlike investor 10, may contribute to issuer 12 not just money, but more importantly, knowledge and network. Investor 20 may be a traditional accredited angel investor, accredited venture capitalist, an industry old hand, or anyone who is experienced and seasoned in a area. Verification 16 may verify info of investor 20 and make results open to investors or the public. Thus, in addition to info on issuer and portal site, investor 10 may also get verified information of special investors at verification site 16. The background and track record of special investor may further help investor 10 select an issuer and purchase securities.

Special investor plus independent verification service may play an important role in non-equity-based funding events for the general public as well. A special investor, who may invest in an activity via time, knowledge, and experience, may function as guidance for regular people. Verified info of special investor may provide more convincing evidence to help people make decisions.

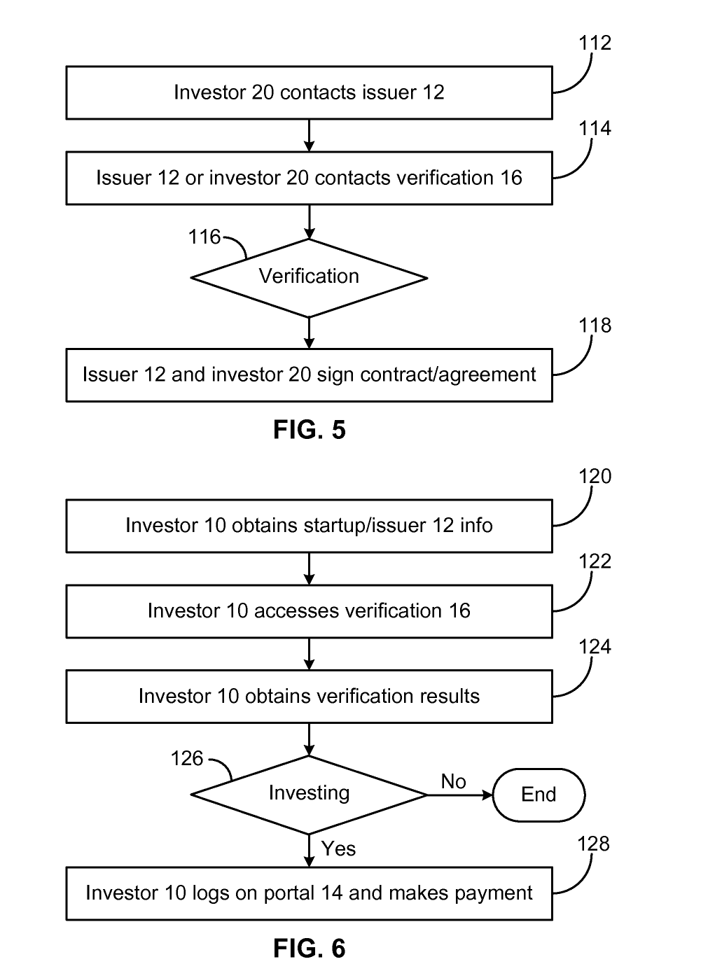

### FIGS. 4 and 5 Special Investor in Fundraising

Arrangement of special investor 20 is graphically illustrated in FIG. 4. First, verification 16 verifies the activities and info of investor 20. For instance, the investigation may cover whether investor 20 has invested in issuer 12, investor 20's credentials such as working experience, education, publications, track record of past investments, and whether investor 20 plans to help issuer 12 with time, knowledge and network. After the verification process is done, the results may be made available to investors at verification site 16. Before, during or after the verification process, issuer 12 may reach an agreement with investor 20, which may include a compensation plan to award the work of investor 20 by securities, part of the fund to be raised, or other forms. Reasonable compensation plans may encourage industry insiders and/or experts to come out to help startups.

FIG. 5 shows an exemplary flow diagram which depicts sign-up activities between issuer 12 and investor 20. In Step 112, investor 20, who may be a seasoned professional in a trade, starts contacting issuer 12 after learning a crowdfunding event. Issuer 12 may need help from old hands like investor 20, and the two may negotiate a deal which may reward investor 20 for work performed. Compared to other investors, the reward may be of bonus-type compensation on top the return of normal monetary investment. For example, investor 20 may purchase one thousand dollars of issuer 12's securities. But unlike investors 10, the regular investors, investor 20 may bring extra values besides money, such as coaching and network. Thus, it's fair and reasonable to compensate for the additional contribution, which may be realized after a crowdfunding round is successfully closed and/or other milestones of company development are met. Milestones may include other rounds of fundraising, a specific revenue target, major sales contracts, or initial public offering (IPO). Next, either issuer 12 or investor 20 may contact verification 16 in Step 114 and requests verification on investor 20. In step 116, verification process is performed. Next, verification reports are sent to issuer 12 and investor 20 respectively. At last, with positive verification result, the two parties may finalize details and formally sign a contract/agreement in Step 118. As the knowledge and experience of investor 20 are much more valuable than the actual money a regular investor may pay for securities, investor 20 may not be required to make any security purchase, and may become an investor using time and knowledge to invest in a startup.

### FIGS. 6—12 Investment Process

With the introduction of independent verification, an improved investment or fundraising process is illustrated exemplarily in FIG. 6. In Step 120, investor 10 may get info of issuer 12 from a portal site or issuer 12's website. The info may include descriptions of business plan, background of company founder or key members, funding history, and so on. But investor 10 may be a little skeptical and thus hesitant to make purchase of securities, because the info isn't from an independent source. As a result, investor 10 may access verification site 16 in Step 122, and obtain related verification results in Step 124. After checking verified investment info, investor 10 may make a final decision in Step 126. Investor 10 may opt out, or opt in and log on portal 14 in Step 128. Finally, investor 10 may start security purchase process.

In Step 124, investor 10 may also access other information provided. For instance, it may include investigation results on portal 14, such as company history and background, any dispute in the past, any fraud involved, etc. Furthermore, the info may contain verification on special investor 20. As info on investor 20 may not be readily available in the public domain due to privacy concerns, verification report of investor 20 may be especially helpful for investor 10.

The embodiment described in FIG. 6 applies to non-equity-based funding activities as well. When people from the general public want to support an effort of others, they may obtain information about the effort in Step 120, log on verification 16 in Step 122, access verified related contents in Step 124, make decisions in Step 126, and then go to portal 14 to make payments in support of the activity in Step 128. The verified info may cover core members of the effort, portal involved, background, and other related information.

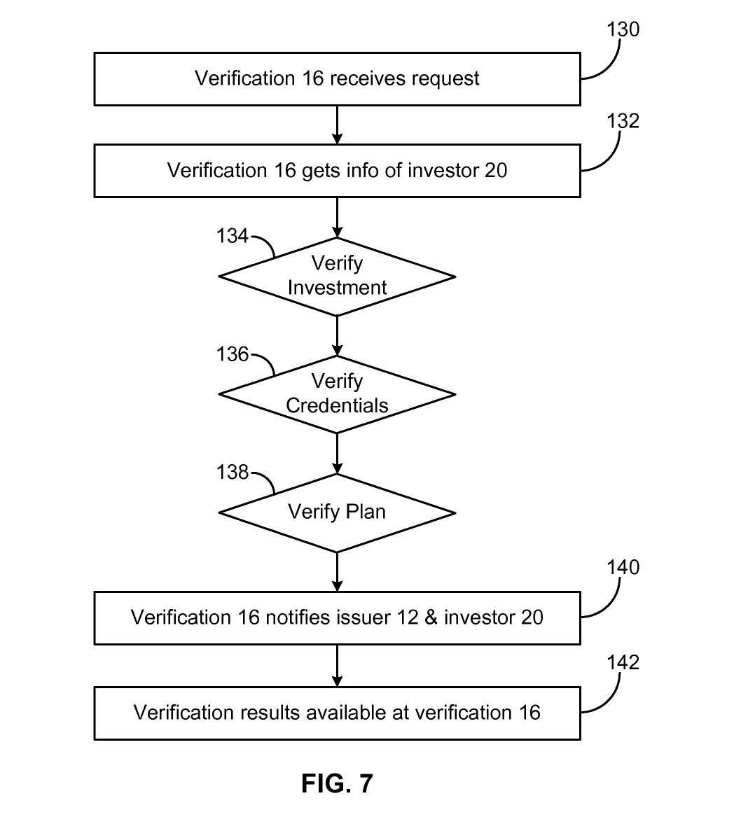

FIG. 7 shows exemplarily a flow diagram of verification process in detail. As discussed in the above, an independent investigation may cover issuer 12, portal 14, or special investor 20, or all of them together. Take investor 20 for example. In Step 130, verification 16 receives a request to verify investor 20. The request may come from issuer 12 or from investor 20. Then a business contract may be made between verification 16 and issuer 12 or investor 20, or among three parties. The contract may include authorization, methods, conditions, and price quotation of verification service. Next, in Step 132, verification 16 starts working and collecting information about investor 20.

Step 134 is focused on verifying investment activity of investor 20, who may have purchased securities of issuer 12 from portal 14 or directly from issuer 12. In the former case, the transaction may be confirmed by contacting portal 14, while in the latter situation, it may be verified through evidence provided from issuer 12. Investor 20 may also invest in issuer 12 by acquiring other forms of its equity, which may be verified, too. Monetary investment of investor 20 is an important indicator to show confidence toward a startup, which is easy to prove and may be valued by regular lay investors.

Step 136 is aimed at credentials of investor 20, which may include education, work experience, academic and/or industrial achievements, awards, honors, publications, records of special investor in the past, and other relevant subjects. Verification 16 may use various channels and sources to do evaluation. Investor 20 may be required to submit a detailed summary as a reference, as well as authorization letter for releasing personal information.

Besides investing in issuer 12, having professional skills, and being seasoned in the field, investor 20 may also be expected to contribute his or her time to coach a possibly young and inexperienced founder or staff of issuer 12. Thus step 138 is designed to verify whether investor 20 is willing to spend time with issuer 12, and whether investor 20 has a reasonably detailed plan to implement it. This step and previous step may involve telephone interviews and/or face-to-face meetings with investor 20 and references.

After a verification process is over, a report may be written. Both issuer 12 and investor 20 may be notified about the results in Step 140. Depending on contract, a verification report may have different kinds that may differ in category, scope, and depth. It is noted that the investment part (Step 134) and plan part (Step 138) may yield relatively straightforward answers, which may be interpreted or summarized either as yes or no. But credential verification is more complicated, since there are no general criteria or standards, and each investor is distinct and special. The report may also expose certain weakness of investor 20 in some area. Nonetheless this part provides a critical element: Records of past involvement as a special investor. A good or bad track record may clearly demonstrate investor 20's investment vision and wisdom.

Next in Step 142, verification results on investor 20 are made available to registered users or even the general public at verification site. Depending on the consent document signed by investor 20, it may be determined what info may be released to what level of investors. For example, unregistered users may only access final conclusions, while registered and qualified users may get more details about the results if allowed by regulations and authorized by investor 20. With all the supporting materials, it is up to each investor to make a judgment call about whether to follow a seasoned professional to invest in a startup.

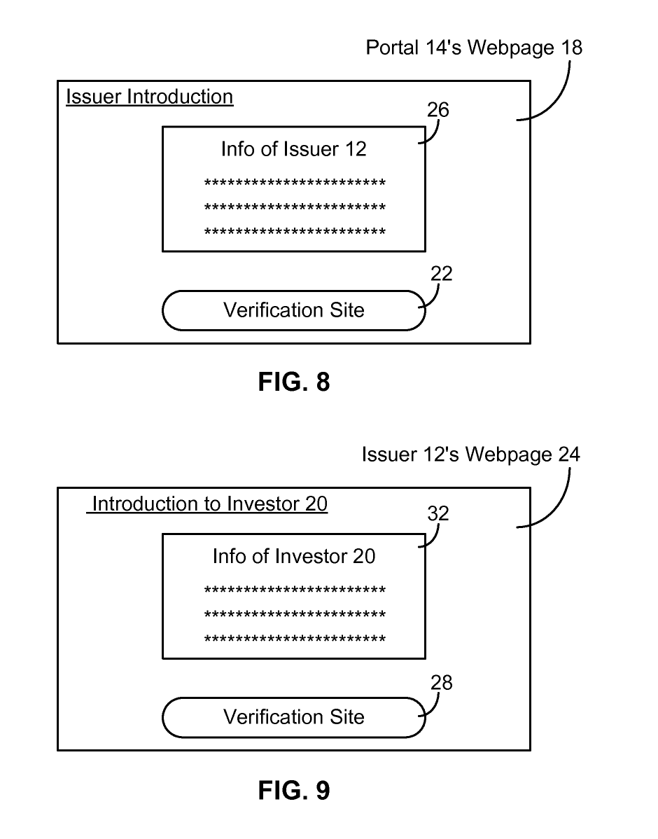

As an independent entity, site 16 may be the only place where verified information on portal 14, issuer 12, and investor 20 is accessible. Thus, one of portal 14's webpages may contain a link button which leads users to site 16, as shown graphically in FIG. 8. In the figure, a webpage 18 may display general information of issuer 12 in a window 26, such as brief introduction of company, founder/other core members, field of business, funding status, previous investors, etc. Basic information about investor 20 may or may not be placed on webpage 18, which may be determined by crowdfunding regulations and the contract between issuer 12 and portal 14. For the convenience of investors to check verified info, a button 22 may be placed on the page, which a user may click on to get directed to verification site 16. A portal site may also provide its own history and records of incident for potential and existing investors, which may also be verified by site 16.

On the other hand, issuer 12 may show off itself and special investor 20 on its site, the latter of which is shown exemplarily on a webpage 24 in FIG. 9. In a window area 32, investor 20, as a skilled industry insider and supporter of the startup company, may be introduced to users or investors. To further convince potential and existing investors, a button 28 is arranged below window 32. An investor may click on it to go to site 16, where independent verification results may be available. The linkage function of button 28 makes it easy and quick to learn more about issuer 12 like a strong founder or strong backer, which is a crucial factor during startup selection. Aside from investor 20, issuer 12's site may also post info to introduce portal 14, its selected fundraising partner.

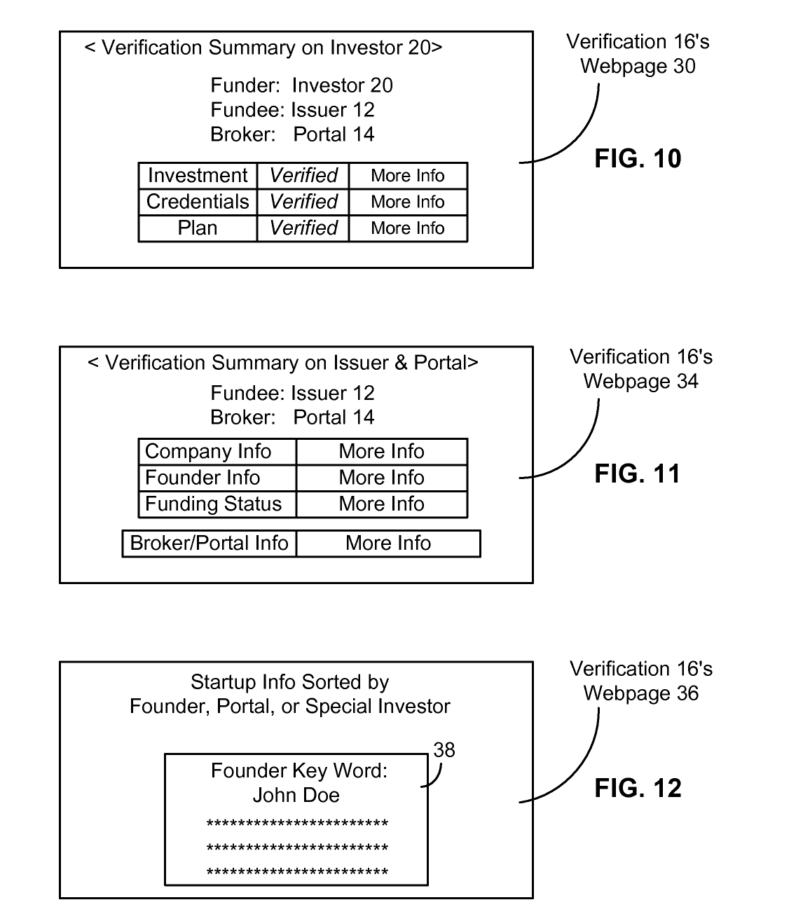

FIG. 10 graphically illustrates a webpage of verification site 16. When a user logs on the site, registration may be required for getting certain information. The site may communicate with portal 14 or issuer 12 to confirm whether a user is registered at their sites. Then the site may determine what information could be released, for the purpose of privacy protection. In FIG. 10, for example, a verification summary on investor 20 may be shown on a webpage 30 with three categories: Investment, credentials, and plan. The summary may point out what part is verified. Investors may click on “More Info” to obtain details. The page may contain names of fundee (issuer 12) and broker (portal 14), plus respective brief summaries.

Site 16 may also provide verified information of issuer 12 and portal 14 as described schematically in FIG. 11. On a webpage 34, another investigation summary is presented. The summary lists various information of issuer 12 like company background, founder background, and financial status. Information of the portal may be posted on the webpage as well. The site may further assure investors that information about issuer and portal is good and trustworthy to use in a fundraising event.

As there may be thousands of portals, hundreds of thousands of startups and special investors respectively, there is a need for investors to sort them out by key word quickly and conveniently. FIG. 12 depicts a schematic sorting webpage 36 at verification site 16. The sorting may be carried out, for instance, by three factors: Startup founder, portal, and special investor. In a window area 38, companies founded by Mr. John Doe in the past may be listed along with current status or final outcome some time ago. Therefore, investors may easily learn how many startups a founder had tried in the past and what achievement or failure had been made. Investors may also quickly know the track record of a portal by sorting the database using portal name. Additionally, if investors want to follow a special investor, they may check his records with startups with which he or she had been working, and how the startups fared afterwards.

### CONCLUSION, RAMIFACTIONS, AND SCOPE

Thus it can be seen that method and system are introduced to help crowdfunding events.

The improved method and system have the following features and advantages:
(1). Independent verification body to check startups/issuers, portals, and special investors;
(2). Verified info of startup/issuer and portal;
(3). Verified info of investment, credentials, and plan of special investors;
(4). Verified info made available to potential and existing investors.

Although the description above contains many specificities, these should not be construed as limiting the scope of the invention but as merely providing illustrations of some of the presently preferred embodiments. Numerous modifications will be obvious to those skilled in the art.

### Ramifications:

Investor 20 may comprise an investor, a company like venture capital firm, or a combination of individual investors and companies. In the latter case, multiple verification processes may be carried out to examine each one respectively.

Even if investor 20 has poorly prepared plan or doesn't want to contribute time to assist issuer 12, as long as he or she purchases and holds issuer 12's securities, his or her investment may still be considered as a helpful indicator for lay investors 10.

Since investors may get info from site 16, which helps the business of portal 14, it may be fair for portal 14 to pay service fees to site 16. In other words, verification site 16 may request portal 14 to enter a business contract with a price quote, when companies promoted by portal 14 are featured on site 16.

Site 16 and portal 14 may be any person or business entity, one acting as a verification body, while the other as a middleman in security transactions. The service and/or transaction may be arranged online, in person, or through any other means. For the convenience of investors, online operation is preferred, i.e. both site 16 and portal 14 may employ online platform with website accessible to registered users and/or the general public.

The embodiments shown in FIGS. 10, 11, and 12 apply to non-equity-based funding efforts as well. Any verified info presented is clearly helpful for all kinds of fundraising events, no matter security investment is involved or not.

Lastly, depending on the contract with issuer 12 and/or investor 20, verification 16 may verify multiple items or only one item, such as startup info, portal info, or any aspect of special investor among investment record, credentials, and plan.

Therefore the scope of the invention should be determined by the appended claims and their legal equivalents, rather than by the examples given.

1. A method performed for the offer or sale of securities by an issuer, comprising:
1) offering said securities to a first investor and a plurality of non-accredited second investors through a broker or funding portal;
2) obtaining initial information from said first investor;
3) verifying investor information of said first investor through verification service;
4) said investor information comprising at least one of the following items:
(a) first information of transaction of said securities involving said first investor;
(b) second information comprising professional experience of said first investor;
(c) third information related to the intention or plan of said first investor to spend time helping said issuer; and
5) providing to said plurality of second investors at least one summary based on said investor information by said verification service.

2. The method according to claim 1 wherein said verification service is independent of said issuer, said broker, or said funding portal.

3. The method according to claim 1, further including compensating said first investor, the compensation related to said investor information.

4. The method according to claim 1 wherein said first investor includes a plurality of investment entities and/or at least one organization entity.

5. A method performed by an issuer for working with and compensating a first investor, said issuer offering or selling securities through a broker or funding portal, comprising:
1) obtaining investor information of said first investor;
2) said investor information comprising at least one of the following items:
(a) first information comprising professional experience of said first investor;
(b) second information related to the intention or plan of said first investor to spend time helping said issuer;
3) negotiating compensation method with said first investor, the compensation related to said investor information; and
4) arranging at least part of said investor information accessible to a plurality of non-accredited second investors, said second investors being offered with said securities by said broker or funding portal.

6. The method according to claim 5, further including arranging said first investor to purchase said securities;

7. The method according to claim 5 wherein said investor information is verified by verification service independent of said issuer, said broker, or said funding portal.

8. The method according to claim 5 wherein said first investor includes a plurality of investment entities and/or at least one organization entity.

9. The method according to claim 5 wherein said compensation is related to the result of at least one funding round.

10. A method performed for providing fundraising information, the fundraising arranged to support efforts of at least one individual or organization, comprising:
1) obtaining said fundraising information;
2) said fundraising information comprising at least one of the following items:
(a) first information related to said efforts;
(b) second information related to a broker or funding portal which involves in said fundraising;
3) generating at least one summary based on said fundraising information;
4) making said at least one summary accessible to a plurality of non-accredited investors or the general public; and
5) said obtaining, generating, and making steps performed by a verification body, said verification body independent of said broker, said funding portal, said at least one individual, or said at least one organization.

11. The method according to claim 10 wherein said fundraising information comprises third information related to the intention or plan of at least one professional who plans to spend time helping said efforts.

12. The method according to claim 10 wherein said fundraising information comprises third information related to the professional experience of at least one professional who plans to spend time helping said efforts.

13. The method according to claim 10 wherein said fundraising information comprises third information related to a compensation scheme, said scheme awards at least one professional who has experience in the industry and plans to spend time helping said efforts.
